(19) United States
(12) Patent Application Publication
(10) Pub. No.: US 2009/0263027 A1
(43) Pub. Date: Oct. 22, 2009

(54) IMAGE PROCESSING METHOD

(75) Inventors: Hiroshi ABE, Niigata-ken (JP); Makoto YAZAWA, Niigata-ken (JP); Kenichi ICHIKAWA, Niigata-ken (JP)

Correspondence Address: Beyer Law Group LLP, P.O. BOX 1687, Cupertino, CA, 95015-1687, US

(73) Assignee: ALPS ELECTRIC CO., LTD., Tokyo (US)

(21) Appl. No.: 12/491,979

(22) Filed: Jun. 25, 2009

Related U.S. Application Data
(63) Continuation of application No. PCT/JP2007/075074, filed on Dec. 27, 2007.

(30) Foreign Application Priority Data
Dec. 28, 2006 (JP) 2006-355702

(51) Int. Cl. G06K 9/68

(52) U.S. Cl. 382/218

(57) ABSTRACT

In an image processing method, extraction points are set inside the draw line as the region with less luminance change relative to the periphery, and extraction points are set on the background outside the draw line in a sample image such as a letter and a number. Pixel data of the extraction points are used to obtain the normalization correlation coefficient with respect to the target image in the determination region. As the template data are generated using pixel data of two groups of the extraction points with clear contrast in the luminance difference therebetween, the true image to be determined as being the same as the template image is detected accurately through the calculation for a short period of time.

### CLAIM OF PRIORITY

This application claims benefit of the Japanese Patent Application No. 2006-355702 filed on Dec. 28, 2006, which is hereby incorporated by reference.

### BACKGROUND OF THE INVENTION

1. Field of the Invention

The present invention relates to an image processing method which employs data of a template for retrieving a true image which is similar to or matches a sample image from target images which include at least one of a letter, number, code or graphic figure.

2. Description of the Related Art

A matching process for matching respective pixel data of a sample image such as the specific letter, number, code and the graphic figure to respective pixel data of the target image has been known as the image processing method for identifying the letter, number, code or graphic figure contained in the target image picked up by the CCD and MOS.

The amount of calculation for matching all the pixel data which form the target image to all the image data which form the sample image becomes immeasurably large. Especially when retrieving the image which is similar to or matches the sample image with high probability from the target image with large area and large number of pixels, the resultant calculation amount will become further huge. It is assumed that the target image includes 512×480 pixels, and the sample image for representing the specific letter, number, code or the graphic figure includes 64×64 pixels. In the aforementioned case, the amount of calculation for retrieving with the normalized correlation method by shifting the single pixel to the entire region with 64×64 pixels in the target image both in the vertical/lateral directions is expected to exceed 1 billion times.

The pixel data of both the target image and the sample image are decimated to calculate the similarity between those data by comparing the reduced number of pixel data. The decimation of the pixel data may make the feature of the image data unclear, which is likely to cause a detection error of the image.

In Japanese Unexamined Patent Application Publication No. 2004-062631 as described below, the edge region of the letter is detected to be used for matching in order to preserve the configuration feature of the image upon decimation of the pixel data to be calculated.

In the method for identifying the target image based on the template information generated by extracting the edge region as disclosed in Japanese Unexamined Patent Application Publication No. 2004-06263 1, the image processing for extracting the edge region is complicated, thus further complicating the calculating process. The aforementioned method may be effective for the case where the number of the pixel data of the target image is the same as that of the pixel data of the sample image, and each number of the pixel data of both the target image and the sample image is small. However, the use of the aforementioned method is not realistic if the area of the target image is wider than that of the sample image, and matching of each of plural determination regions obtained by dividing the target image to the template information is calculated because of huge total calculation amount.

### SUMMARY OF THE INVENTION

The present invention provides the image processing method capable of determining with respect to the similarity or matching between the target image and the sample image with high accuracy while having the calculation amount reduced.

The present invention provides an image processing method capable of calculating as to existence of the image that is similar to or matches the sample image in the target image with the area larger than that of the sample image with high probability accurately for a relatively short period of time.

In the image processing method for determining a similarity between target image data to be identified and template data, plural points in an inner region of a draw line of any one of a letter, a number, a code and a graphic figure contained in a sample image, and plural points outside the draw line are set as extraction points to generate the template data based on information with respect to each position and luminance of the plural extraction points.

In the image processing method, a template is generated by setting extraction points in both inner and outer regions of a draw line while excluding each edge region of a letter, a number, a code or a graphic figure. The luminance change between the extraction point and the adjacent pixel data becomes less by avoiding the edge region. Although the number of the extraction points in the sample image is reduced, that is, the rate of the pixel data decimation to be used is increased, the template which allows accurate detection of the target letter and number may be obtained without deteriorating the feature of the image.

For example, a calculation region which contains plural pixel data in the sample image is set to obtain a sample variance of the plural pixel data in the calculation region. Plural calculation regions where the sample variance becomes equal to or smaller than a predetermined value are extracted. At least one pixel in the extracted calculation regions is set as the extraction point.

The extraction point may be a single pixel at the center of the calculation region, or plural pixel data gathered at the center. Alternatively, the extraction points may be plural pixel data located apart from one another in the calculation region. As the sample variance, all the pixel data in the calculation region may be subjected to the calculation, or plural arbitrary pixel data in the calculation region may be used for calculating the sample variance.

In the method, data of the obtained extraction points are arranged in the order of the luminance to select a group of the plural extraction points in a range with a high luminance at one side with respect to a boundary portion of a luminance change. A group of the plural extraction points in a range with a low luminance are selected in a range with a low luminance at the other side with respect to the boundary portion of the luminance change. The template data are generated based on information with respect to each position and the luminance of the selected groups of the extraction point.

The pixel data of the thus selected extraction points may be classified into a group with high luminance and a group with low luminance. In the case where normalized correlation between the template data and the target image data is obtained, the resultant value of luminance of the similar letter, number, code or the graphic figure becomes high. Meanwhile, the resultant value of the dissimilar data becomes low. This makes it possible to execute the matching with high accuracy.

In this case, selection of the same numbers of the extraction points in the range with the high luminance at the one side and the extraction points in the range with the low luminance at the other side with respect to the boundary portion of the luminance change allows the matching to be executed accurately using the normalized correlation.

In the method, preferably, the extraction points which are separated by a distance equal to or larger than a predetermined value are used for generating the template data.

The use of the separated extraction points may increase the rate for decimating the pixel data, and sufficiently detect the features of both images.

In the method, preferably, the target image contains a true image determined to be similar to the sample image and a false image determined to be dissimilar to the sample image, and a point at which the luminance difference between the true and the false images overlapped with each other becomes large is selected as the extraction point.

In the method, the target image contains plural true images to be determined as being similar to the sample image. When the plural true images have different dimensions, it is preferable to select the extraction point in a region where draw lines of the plural images with different dimensions are overlapped.

When the extraction point is selected as described above, the method ensures to distinguish the image of the number “6” from the look alike number “8”, and to detect the same number and letter with different size such as “6”, for example.

In the method, determination regions each with a size for containing the sample image are set on the target image with an area larger than that of the sample image to allow the determination regions to be shifted sequentially in the target image. The image data at the same position as the extraction point of the template is extracted from the target image in each of the respective determination regions to obtain a correlation coefficient between the image data and the template data. When the correlation coefficient is equal to or larger than a predetermined value, it is determined that a true image similar to the sample image exists at a position in the determination region.

In the method, the use of the general calculation method for obtaining the normalized correlation ensures to identify the letter and the number with high accuracy.

In this case as the number of the extraction points may be reduced, the calculation with respect to the entire region of the target image may be executed for a short period of time even if the determination is made by shifting the single pixel in the determination region.

In the method, the correlation coefficient is calculated by shifting the determination region by one point toward each direction from a state where the true image is overlapped with the determination region in the target image to reach a distance half the calculation region to set a minimum correlation coefficient value as a true worst value. The correlation coefficient between data in all the determination regions in the target image and the template data to set a maximum value of the correlation coefficient in the determination region which does not contain the true image as a false maximum value. The extraction point of the template is changed to allow the true maximum value to become larger than the false maximum value.

Execution of the aforementioned operation further improves the detection accuracy of the image using the template data.

The method allows the letter, number, code or the graphic figure in the target image to be detected with high accuracy while having less calculation amount. The method also allows the letter, the number, the code or the graphic figure to be detected from the target image with larger area, while having the calculation amount reduced.

### BRIEF DESCRIPTION OF THE DRAWINGS

FIG. 1 is a block diagram of an image processing device for executing an image processing method according to an embodiment of the present invention;

FIG. 2A is an explanatory view of a sample image;

FIG. 2B is an explanatory view of a target image;

FIG. 3 is an explanatory view showing a relationship between the sample image and a calculation region;

FIG. 4 is an explanatory view of a method for selecting an extraction point from the sample image;

FIG. 5 is a diagram showing the luminance change of the pixel data on the line V-V across the sample image shown in FIG. 3;

FIG. 6 is an explanatory view showing a region where the extraction point is selected from the sample image;

FIG. 7 is an explanatory view with respect to the distribution where the extraction points are arranged in the order of luminance;

FIG. 8 is an explanatory view showing the process for selecting the extraction point from the sample image;

FIGS. 9A to 9C are explanatory views each showing the process for evaluating the template using the normalization correlation coefficient;

FIGS. 10A and 10B are explanatory views each showing the process for generating the template for distinguishing the target letter and number from those look alike; and

FIGS. 11A and 11B are explanatory views each showing the process for generating the template for distinguishing the target letter and number from those with different sizes.

### DESCRIPTION OF THE PREFERRED EMBODIMENTS

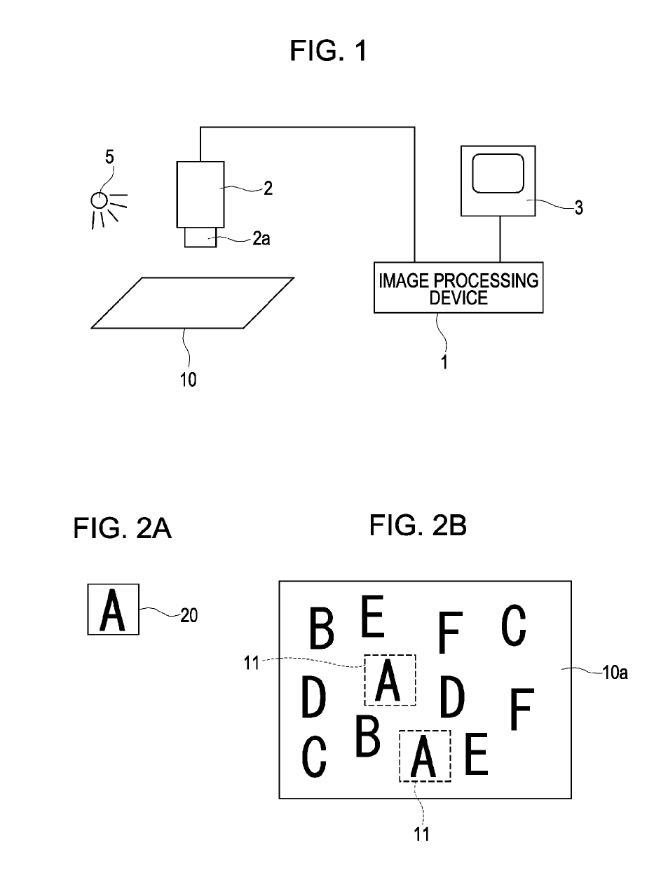

FIG. 1 is a block diagram of an image processing device 1 for executing an image processing method according to an embodiment of the present invention.

A camera 2 is connected to the image processing device 1. The camera 2 includes a lens 2a, having an image pickup device such as a CCD or a CMOS. The image pickup device includes plural pixels. When the light is irradiated from an illumination light source 5 to a target 10 which contains at least one of a letter, a number, a code and a graphic figure, the reflecting light from the target 10 is picked up by the camera 2 to provide a target image 10a as shown in FIG. 2B.

The image processing device 1 is formed of a CPU, a memory and the like. The pixel data (luminance data) derived from the respective pixels of the image pickup device are subjected to an A/D conversion, and sent to the CPU as data with 256 tones, for example. A monitor 3 with a CRT or a liquid crystal panel is connected to the image processing device 1.

The target 10 includes plural letters written on the surface. Those letters are formed by printing, stamping, or etching of the metal film. The draw line of the letter is dark in color, and the entire background other than the draw line is light in color, for example, white. In the state where the image is picked up by the camera 2 by supplying the illumination light from the illumination light source 5, the luminance of the draw line of the target image 10a is low, and the luminance of the background other than the draw line is high. The image processing device 1 is suitable for identifying the letter, for example, the dark colored letter on the light colored background of the target.

FIG. 2 shows the embodiment having plural alphabetical letters on the target 10. The image processing device 1 detects the letter “A” among those plural letters, and the location thereof.

Template data are stored in a memory of the image processing device 1 as the reference for detecting the letter “A”. The template data are generated from a sample image 20 as shown in FIG. 2A. The letter “A” of the sample image 20 has the same type and the same size as those of the letter “A” contained in the target image 10a, or the similar type and the similar size to those of the letter “A” contained in the target image 10a. The area of the sample image 20 is substantially smaller than that of the target image 10a.

FIG. 2B shows a determination region 11 as a square region enclosed by dashed line on the target image 10a derived from picking up the target 10 so as to be compared with the template data. The area of the determination region 11 is the same as that of the sample image 20. The determination region 11 has the same number of pixels as that of the sample image 20.

### Generation of Template Data

The process for generating the template data from the sample image 20 will be described.

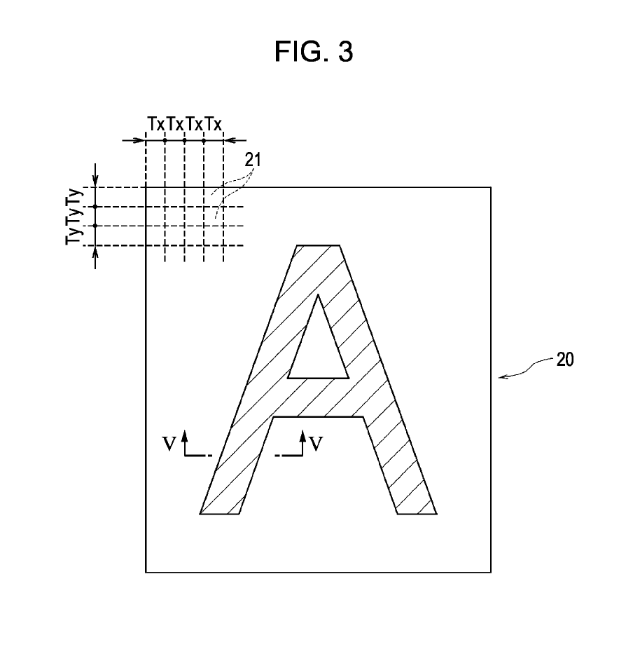

FIG. 3 shows an enlarged view of the sample image 20. The sample image 20 is formed by extracting the region with the same area as that of the determination region 11, and having the letter “A” centered from the target image 10a shown in FIG. 2B. The sample image 20 has the region with 64×64 pixels. The region of 64×64 pixels is assumed to be formed inside the image processing device 1 using the software such that the sample image 20 having the letter “A” at the center is drawn on the computer by distributing dark and light colors to the respective pixels.

In the embodiment, all the pixel data of the sample image 20 having 64×64 pixels are not used as the template data. The pixel data in the sample image 20 are decimated so as to use the pixel data as the extraction points as least as possible. The process for extracting the data will be described hereinafter.

### (1) Extraction of Pixel Data In the Peripheral Region With Less Luminance Difference Relative To the Periphery

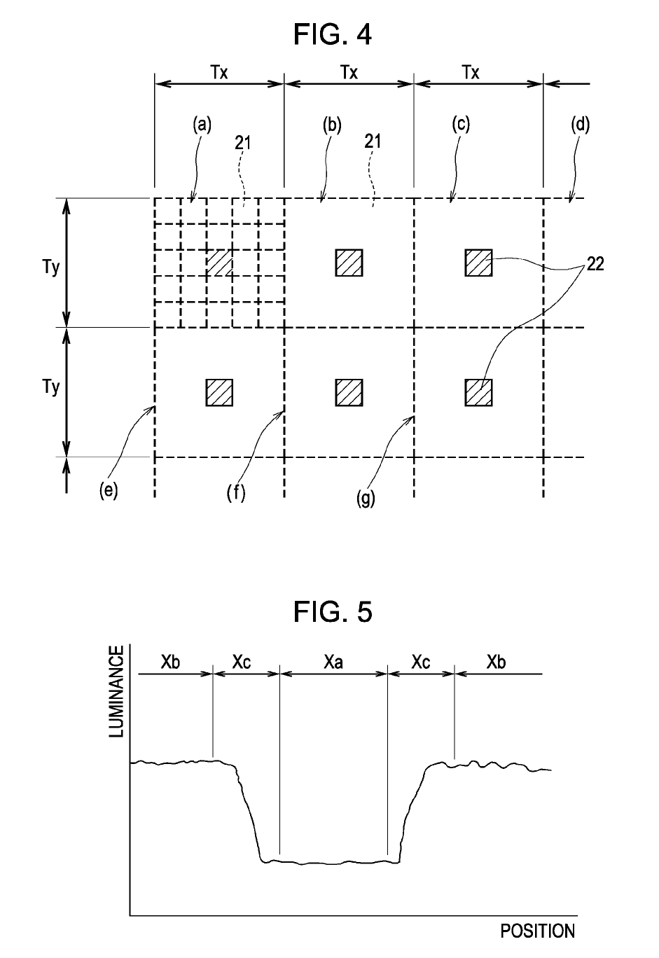

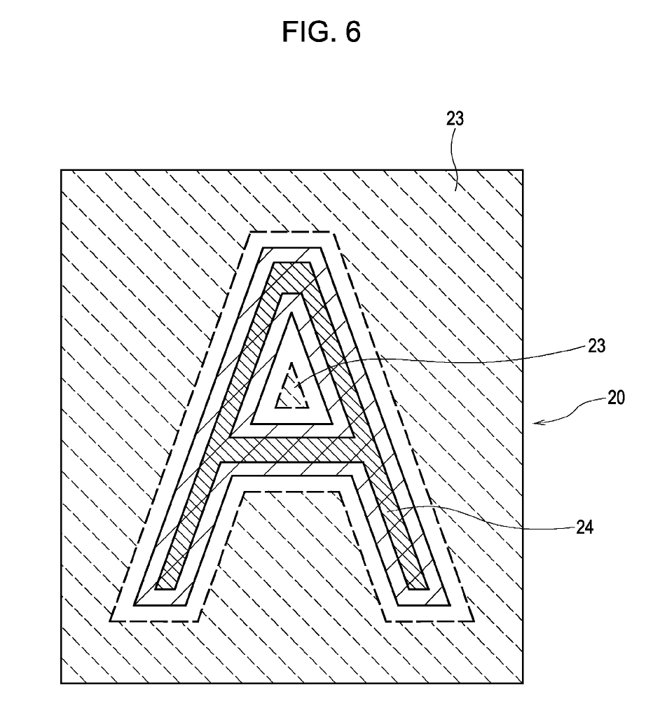

Referring to FIG. 3, calculation regions 21 each having a predetermined area (predetermined number of pixels) are set on the sample image 20. The calculation region 21 has a longitudinal dimension of Ty and the lateral dimension of Tx. The area Tx×Ty contains at least 3×3=9 pixels, that is, 3 pixels in both the longitudinal and the lateral directions. FIG. 4 shows an enlarged view of the calculation region 21. In the embodiment, 5 pixels are arranged along the longitudinal dimension, and 5 pixels are arranged along the lateral dimension. That is, the single calculation region 21 contains 5×5=25 pixels.

The image processing device 1 sequentially scans the sample image 20 for each unit of Tx×Ty, that is, each pixel group of 5×5=25 so as to calculate the sample variance of the pixel data in the respective calculation regions 21. Referring to FIG. 4, the sample variance is calculated in the calculation region 21 as (a) with the area of Tx×Ty (5×5=25 pixel group). Then in the next calculation region 21 as (b) with the area of Tx×Ty (5×5=25) by 5 pixels in the lateral direction for calculating the sample variance. The aforementioned operation is repeatedly performed. The sample variance is calculated in the calculation regions 21 arranged at every 5 pixels in the lateral direction, that is, (a), (b), (c), (d), and the like, and then the sample variance is further calculated in the subsequent calculation regions 21 laterally arranged at every 5 pixels below the aforementioned calculation regions 21, that is, (e), (f), (g), and the like.

The sample variance δ2 using the pixel data in the respective calculation regions 21 is calculated based on the following formula 1.

$${δ}^{2} = \frac{{\sum }_{i = 1}^{n} {( xi - x )}^{2}}{n} \qquad Formula 1$$

In the formula 1, n denotes the number of pixels in the single calculation region 21, which is 25 in the embodiment shown in FIG. 4. The code xi denotes the pixel data of each pixel in the single calculation region 21. The respective pixel data may be expressed with 256 tones. The x bar of the formula 1 (the letter with line above x) denotes the average value of the 25 pixel data in the single calculation region 21. The sample variance δ2 expressed in the formula 1 is calculated for all the calculation regions 21, that is, (a), (b), (c) and the like as shown in FIG. 4.

The sample variance δ2 has its value decreased to approach zero as fluctuation of 25 pixel data in the calculation region 21 becomes lower, and its value increased as fluctuation of 25 pixel data in the calculation region 21 becomes higher. In the embodiment, the calculation region 21 having the calculation result of the sample variance δ2 equal to or smaller than a predetermined value, or the one smaller than a predetermined threshold value is selected. At least one pixel in each of the respective calculation regions 21 is selected as the extraction point. In the embodiment shown in FIG. 4, the pixel data centered in the calculation region 21 having the sample variance δ2 equal to or smaller than the threshold value or smaller than the threshold value are selected as data of the extraction point 22.

The sample variance is calculated through the formula 1 in the respective calculation regions 21 such that the extracting point 22 is selected from the region with less fluctuation of the luminance difference between the peripheral pixels. At the time when the extraction point 22 is selected in each of the respective calculation regions 21, the pixel data of the sample image 20 used for the calculation may be reduced to 1/25.

FIG. 5 shows a distribution of the pixel data (luminance data) of the respective pixels on the line V-V laterally extending across the draw line of the letter “A” on the sample image 20.

In the inner region of the draw line of the letter “A” on the sample image 20, the luminance of the image data is low. Meanwhile, in the region outside the draw line, the luminance of the image data is high. The calculation region 21 having the sample variance δ2 of the formula 1 equal to or smaller than the threshold value or smaller than the threshold value becomes the region Xa as the filled inner region, and the region xb as the region outside the draw line having the background colored in white. In a region Xc which contains the boundary between the draw line and the background, the respective pixel data in the calculation regions 21 largely fluctuate, resulting in the large value of the sample variance δ2. The extraction point 22 is selected from the region with small the value of the calculated sample variance δ2 so as to prevent the use of the data in the region Xc with the large fluctuation as shown in FIG. 5 for the calculation.

As a result, the extracting point 22 may be selected from a region 24 inside the draw line of the letter “A” apart from the edge thereof, and a region 23 in the background region apart from the draw line, and apart from the edge thereof.

### (2) Selection of Extraction Point From the Region With Low Luminance And the Region With High Luminance (Extraction Point Is Selected Such That the Luminance of the Extraction Points Markedly Differ)

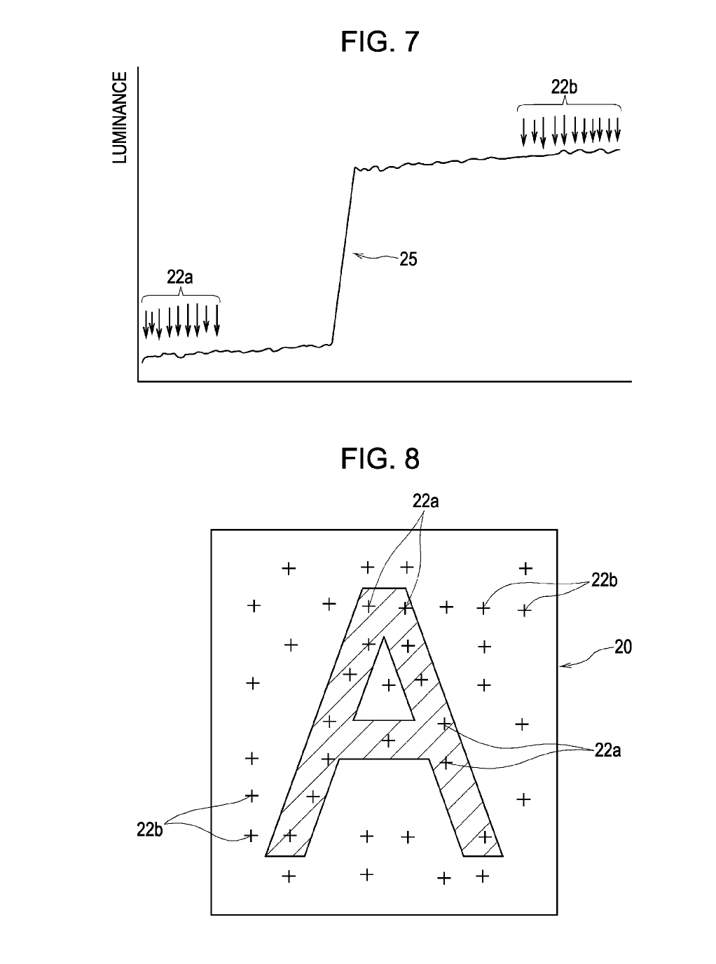

Referring to FIG. 7, the extraction points 22 selected in the section (1) are arranged in the order of the lowest to the highest luminance. In the section (1), the extraction point 22 is selected from the calculation region 21 with the low sample variance δ2. The extraction points 22 are in the region 24 inside the draw line and inside the background region apart from the draw line, which are not selected from the boundary of the draw line. In the luminance distribution, the extraction points 22 with low luminance are arranged at one side, and those with high luminance are arranged at the other side with respect to a border between those groups.

After arranging the extraction points as shown in FIG. 7, plural extraction points 22a are selected from the group with the lowest luminance, and plural extraction points 22b are selected from the group with the highest luminance. The extraction points 22a may be selected every other or every two points from the lowest luminance. Preferably, however, the plural extraction points 22a are selected sequentially from the lowest luminance. This may apply to selection of the extraction points 22b from the group with the highest luminance.

As a result, the extraction points 22a are selected from the darkest colored region inside the draw line of the letter “A”, and the extraction points 22b are selected from the lightest colored region on the background apart from the draw line of the letter “A”.

### (3) Selection of Separated Extraction Points

Among the plural extraction points 22a at the low luminance side, if any one of longitudinal and lateral distance between those points is shorter than a predetermined value, the extracting point 22a with lower luminance is only selected. Likewise, among the plural extraction points 22b at the high luminance side, if any one of the longitudinal and lateral distance between those points is shorter than the predetermined value, the extraction point 22b with higher luminance is only selected.

There is a high probability that the adjacent extraction points 22a exist in the portion with the same feature of the letter. The adjacent extraction points may be decimated to reduce the calculation amount without deteriorating the feature of the template data. This may apply to the case of the extraction points 22b.

### (4) Selection of the Same Numbers of Extraction Points In Both Groups With the Low Luminance And the High Luminance

Preferably, the number of the extraction points 22a selected from the lower luminance group is substantially the same as that of the extraction points 22b selected from the higher luminance group. Making the respective numbers of the extraction points 22a and 22b the same or substantially the same allows the correlation coefficient of the similar image to be clearly distinguishable from that of the dissimilar image upon calculation of the normalization correlation coefficient to be described later.

The plural extraction points 22a are selected from the lowest luminance, and the plural extraction points 22b are selected from the highest luminance. The adjacent extraction points 22a are made apart from each other to a certain degree, and the adjacent extraction points 22b are made apart from each other as well. The number of the extraction points 22a is set to be the same or substantially the same as that of the extraction points 22b so as to generate the template capable of detecting the image with the minimum calculation amount without deteriorating the feature of the letter on the sample image 20. The number of the extraction points 22a is substantially the same as that of the extraction points 22b means that the number of any one of the extraction points 22a and 22b is 80% or higher of the number of the other, preferably, 90% or higher.

### Determination With Respect To Target Image

The target image 10a shown in FIG. 2B has the area larger than the sample image 10, for example, having 245760 (512×480) pixels. The determination region 11 with the same area and the same number of pixels with those of the sample image 20 before generating the template data is set on the target image 11a. The determination region 11 is shifted sequentially from the upper left region of the target image 10a laterally by each pixel row. When scanning of the uppermost row is finished, it is shifted down by one pixel column. It is further shifted laterally by the pixel column on the next row to set the determination region 11 sequentially. The determination region 11 is set on the entire region of the target image 10a by shifting longitudinally and laterally by a pixel.

The pixel data of the respective determination regions 11 are compared with the template data. The pixel data at the same positions as the extraction points 22a extracted from the template data are extracted from the 64×64 pixels of the respective determination regions 11. Then the pixel data extracted from the determination region 11 are compared with those of the same numbers of the extraction points 22a and 22b of the template.

The comparison is performed by the normalized correlation method. It is assumed that the pixel data of the respective extraction points 22a and 22b of the template are set to M, and the pixel data extracted from the determination region 11 are set to I, a normalization correlation coefficient R may be obtained by dividing covariance of M and I by the product of standard deviations of M and I as expressed by a formula 2.

$$R = \frac{Covariance of M and I}{\begin{matrix}( Standard deviation of M ) \times \\ ( Standard deviation of I )\end{matrix}} \qquad Formula 2$$

Specifically, the correction coefficient R may be obtained by the following formula 3. The code N in the formula 3 denotes the total number of the extraction points 22a and 22b extracted from the sample image 20. The code N also denotes the number of pixel data to be extracted from the single determination region 11. The code Mi denotes the pixel data of the extraction points 22a and 22b of the template, and the code Ii denotes the pixel data extracted from the determination region 11.

$$R = \frac{N \cdot {\sum }_{i - 1}^{N} Mi \cdot Ii - {\sum }_{i - 1}^{N} Mi {\sum }_{i - 1}^{N} Ii}{\begin{matrix}\sqrt{N \cdot {\sum }_{i = 1}^{N} {Mi}^{2} - {( {\sum }_{i = 1}^{N} Mi )}^{2}} \times \\ \sqrt{N \cdot {\sum }_{i = 1}^{N} {Ii}^{2} - {( {\sum }_{i = 1}^{N} Ii )}^{2}}\end{matrix}} \qquad Formula 3$$

When the correlation coefficient R becomes equal to or larger than a predetermined threshold value, or exceeds the threshold value, it is determined that a true image regarded as being the same as or similar to the sample image 20 exists in the determination region 11. Upon detection of the target image 10a as shown in FIG. 2B, the calculated correlation coefficient R in the determination region 11 having the letter “A” at the center becomes maximum. The correlation coefficients of the respective determination regions 11 and the template are calculated sequentially to detect the maximum calculated value. This makes it possible to locate the position at which the letter “A” as the true image exists in the target image 10a.

The template data are obtained by taking the image data of the extraction points 22a and 22b from the sample image 20. The number of the pixel data is relatively smaller than the total number of pixels of the sample image. The same number of the pixel data as the template data are extracted from the pixel data inside the determination region 11 to calculate the normalization correlation coefficient. The total amount of calculation of the correlation coefficients R in all the determination regions 11 is relatively small, which makes it possible to detect the location of the true image (letter “A”) by the calculation taken for a short period of time.

Although the number of the pixel data of the template is small, the data are extracted from the extraction points 22a in the region inside the draw line of the letter with the same luminance relative to periphery and the extraction points 22b on the background other than the letter and apart from the edge of the draw line on the sample image 20. That is, the template data clearly reflects the contrast of the sample image. Accordingly, the true image may be detected with high accuracy in spite of small number of the extraction points 22a and 22b. The normalized correlation calculation is performed using the pixel data with less extraction points, thus allowing the calculation for the short period of time.

### Verification of Accuracy In Template Data

(a) Verification of Calculation Result of Normalization Correlation Coefficient

Referring to FIG. 4, the pixel of the sample image 20 is divided into the calculation regions 21 each with the area of Tx×Ty for generating the template data. If each sample variance of all the pixel data in the calculation region 21 is smaller than the predetermined value, the pixel data at the center of the calculation region 21 are set as the extraction points 22. The extraction points 22a and 22b which realize clear contrast are detected from those extraction points 22 as shown in FIGS. 7 and 8. The template data are evaluated as below to further generate the template with high detection accuracy.

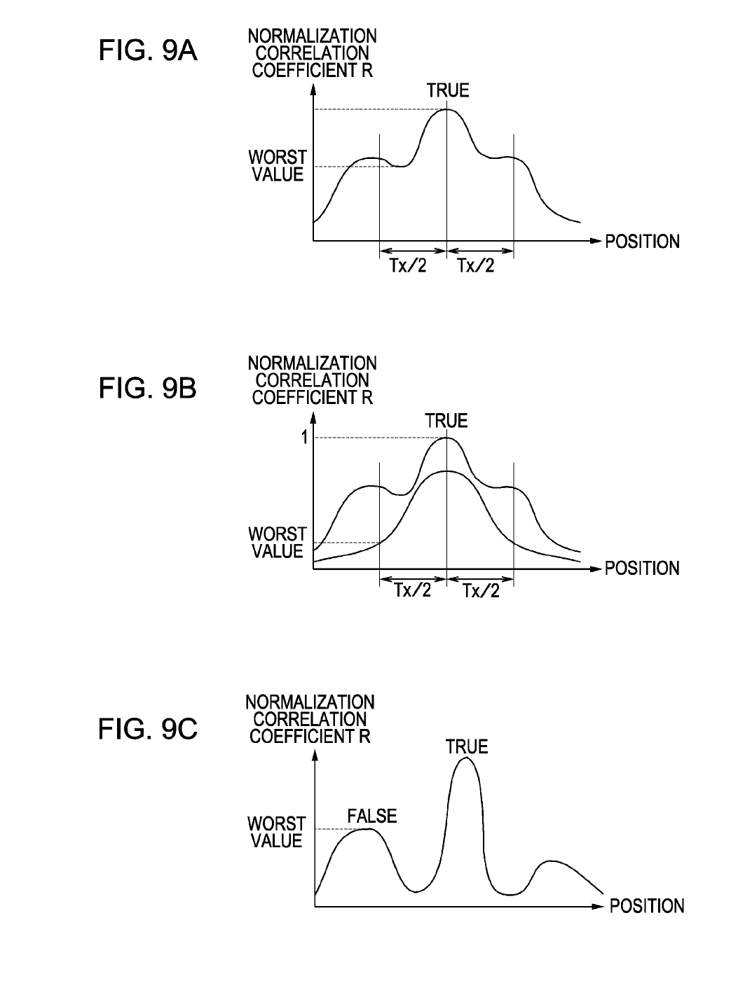

FIG. 9A represents the normalization correlation coefficient R calculated using data of the plural determination regions 11 and the template data around which the letter “A” that is the same as the sample image 20 exists in the target image 10a as shown in FIG. 2B. FIG. 9A shows the correlation coefficient R in the determination region 11 at each position resulting from each shift of the determination region 11 rightward and leftward by the single pixel from the center of the letter “A” in the target image 10a.

Referring to FIG. 9A, in the determination region 11 where the center of the letter “A” of the sample image 20 matches the center of the letter “A” as the true image of the target image, the normalization correlation coefficient R becomes maximum, which will be referred to as the true maximum value. The minimum value of the correlation coefficient R of the determination region 11 and the template in the range of Tx/2 leftward and rightward from the position at which the correlation coefficient R becomes maximum will be referred to as a true worst value.

The true worst value reflects the detection error caused by decimating the pixel other than the extraction point 22 in the range Tx upon generation of the pixel data of the template. Likewise, the determination region is shifted longitudinally by the single pixel row on the target image to obtain the true worst value as the minimum correlation coefficient R in the range of Ty/2 upward and downward from the true maximum value in the same manner as shown in FIG. 9A.

The normalization correlation coefficient R is calculated for all the determination regions 11 shifted by the single pixel column laterally on the target image 10a as shown in FIG. 2B, and further shifted by the single pixel row longitudinally, using the pixel data extracted from the respective determination regions 11 and the template data. Referring to FIG. 9C, the x-axis shows the positions of all the determination regions 11, and y-axis shows the correlation coefficient R calculated for the respective determination regions 11. The correlation coefficient R becomes the true maximum value when the sample image 20 overlaps with the letter “A” as the true image of the target image. The value at the position without the true image, and has the correlation coefficient R second largest to the true maximum value is the false maximum value.

If the extraction points 22a and 22b of the template are determined such that the true worst value shown in FIG. 9A is kept constantly larger than the false maximum value shown in FIG. 9C, the probability of the error of detecting the image other than the true image upon verification of the target image may be reduced. Preferably, the template condition of (true worst value)/(false maximum value) in excess of 1 is established. For example, it is preferable to set the template condition to be in the range from 1.2 to 1.6.

Referring to FIG. 9B, in the case where two types of template data are prepared to detect two true images in the target image, upon detection of the letters “A” and “B”, the extraction points of the template are determined so as to set the smaller value of the true worst values of both the templates becomes larger than the false maximum value.

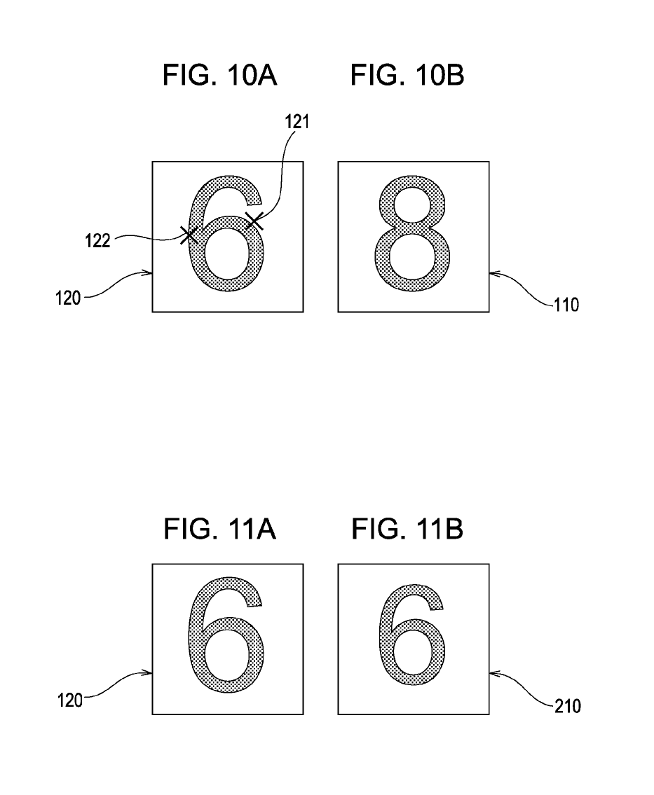

(b) FIG. 10A showing look alike letters, numbers, codes or graphic figures represents the example which uses the number “6” as a sample image 120 for generating the template. In this case, if the target image obtained by picking up the target contains a letter image 110 of the number “8” as shown in FIG. 10B, the value of the correlation coefficient R derived from the pixel data of the template generated from the sample image 120 of the number “6” and the pixel data having the same extraction point as the template with respect to the image of the number “8” becomes high as the respective draw lines of those numbers of “6” and “8” are look alike when they are overlapped. This may be a risk of misidentifying the number “8” for the number “6” as the true image.

Points 121 and 122 at which the draw line of one of the overlapped numbers “6” and “8” exists and the draw line of the other number does not exist are set as new extraction points. At the point 121, the draw line of the number “6” does not exist, but the draw line of the number “8” exists. At the point 122, the draw line of the number “6” exists, but the draw line of the number “8” does not exist. The points 121 and 122 where the luminance difference of the overlapped target image and the sample image becomes large are set as the extraction points. Then the pixel data of the sample image at the points 121 and 122 are added to the template data generated from the sample image. Generation of the template data as described above allows the letters and numbers having the respective draw lines adjacent with each other to be accurately distinguished.

FIG. 11A shows the example for generating the template data from the sample image 120 of the number “6” as described above. The sample image 120 contains an image 210 of the number “6” which is relatively smaller (or larger) than the number “6” on the target image derived from picking up the target as shown in FIG. 11B. In this case, the extraction point 22a in the region where the draw lines of the sample image 120 shown in FIG. 11A and the image shown in FIG. 11B are overlapped is selected. Referring to FIGS. 7 and 8, the extraction point 22a with the low luminance in the region where the draw lines of those two numbers “6” are overlapped is always selected.

Even if the target image contains the image of the same letter and the number with slightly different size, the image of the target image may be detected with high probability.

1. An image processing method for determining a similarity between target image data to be identified and template data, wherein:
plural calculation regions which contain plural pixel data are set in a sample image which contains at least one of a letter, a number, a code and a graphic figure to obtain a sample variance of the plural pixel data in the respective calculation regions, and at least one pixel contained in the calculation region where the sample variance becomes equal to or smaller than a predetermined value is set as an extraction point; and
plural extraction points are extracted from a region inside a draw line of the letter, number, code or the graphic figure, and a region outside the draw line to generate the template data based on information with respect to each position and luminance of the plural extraction points.

2. The image processing method according to claim 1, wherein:
data of the obtained extraction points are arranged in the order of the luminance to select a group of the plural extraction points in a range with a high luminance at one side with respect to a boundary portion of a luminance change; and
a group of the plural extraction points in a range with a low luminance are selected in a range with a low luminance at the other side with respect to the boundary portion of the luminance change; and
the template data are generated based on information with respect to each position and the luminance of the selected groups of the extraction point.

3. The image processing method according to claim 2, wherein the same numbers of the extraction points in the range with the high luminance at the one side and the extraction points in the range with the low luminance at the other side with respect to the boundary portion of the luminance change are selected.

4. The image processing method according to claim 1, wherein the extraction points which are separated by a distance equal to or larger than a predetermined value are used for generating the template data.

5. The image processing method according to claim 1, wherein:
the target image contains a true image determined to be similar to the sample image, and a false image determined to be dissimilar to the sample image;
a point at which the luminance difference between the true and the false images overlapped with each other becomes large is selected as the extraction point.

6. The image processing method according to claim 1, wherein:
the target image contains plural true images to be determined as being similar to the sample image; and
when the plural true images have different dimensions, the extraction point is selected in a region where draw lines of the plural images with different dimensions are overlapped.

7. The image processing method according to claim 1, wherein:
determination regions each with a size for containing the sample image are set on the target image with an area larger than that of the sample image to allow the determination regions to be shifted sequentially in the target image;
the image data at the same position as the extraction point of the template is extracted from the target image in each of the respective determination regions to obtain a correlation coefficient between the image data and the template data; and
when the correlation coefficient is equal to or larger than a predetermined value, it is determined that a true image similar to the sample image exists at a position in the determination region.

8. The image processing method according to claim 7, wherein the determination is made by shifting the determination region by a single pixel.

9. The image processing method according to claim 7, wherein:
the correlation coefficient is calculated by shifting the determination region by one point toward each direction from a state where the true image is overlapped with the determination region in the target image to reach a distance half the calculation region to set a minimum correlation coefficient value as a true worst value;
the correlation coefficient between data in all the determination regions in the target image and the template data to set a maximum value of the correlation coefficient in the determination region which does not contain the true image as a false maximum value; and
the template is selected from plural templates to allow the true worst value to be larger than the false maximum value.

10. The image processing method according to claim 8, wherein:
the correlation coefficient is calculated by shifting the determination region by one point toward each direction from a state where the true image is overlapped with the determination region in the target image to reach a distance half the calculation region to set a minimum correlation coefficient value as a true worst value;
the correlation coefficient between data in all the determination regions in the target image and the template data to set a maximum value of the correlation coefficient in the determination region which does not contain the true image as a false maximum value; and
the template is selected from plural templates to allow the true worst value to be larger than the false maximum value.
